(19) United States
(12) Patent Application Publication
(10) Pub. No.: US 2008/0095414 A1
(43) Pub. Date: Apr. 24, 2008

(54) Correction of functional nuclear imaging data for motion artifacts using anatomical data

(76) Inventors: Vladimir Desh, Glenview, IL (US); Darrell Dennis Burckhardt, Hoffman Estates, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/519,475

(22) Filed: Sep. 12, 2006

(51) Int. Cl. G06K 9/00

(52) U.S. Cl. 382/128

(57) ABSTRACT

A method and system for detecting the presence of motion in functional medical imaging data by comparison with anatomical medical imaging data derived from reconstructed anatomical images. Detected motion in the functional data is then estimated and corrected. In accordance with an example embodiment, CT object templates are produced from reconstructed CT image data and convolved with nuclear medical (SPECT or PET) projection data to detect object motion. Detected motion is estimated to obtain a displacement vector, and the nuclear medical projection data is corrected for objection motion by application of the displacement vector.

### BACKGROUND OF THE INVENTION

1. Field of the Invention

The present invention relates generally to correction of medical imaging data to remove distortions or artifacts, and more particularly to improvements in processing and correction of data acquired by one type of medical imaging device by use of data acquired by another type of medical image device.

2. Description of the Background Art

Medical imaging systems of a number of different imaging modalities are known. Examples of such different modalities include simple planar X-ray, X-ray Computed Tomography (CT), Single Photon Emission Computed Tomography (SPECT), Positron Emission Tomography (PET), Magnetic Resonance Imaging (MRI), and Ultrasound, among others. The particular characteristics of each modality lend themselves to different particular applications.

Diagnostic imaging systems which use multiple imaging modalities have been and continue to be developed. These multimodality systems can yield synergistic advantages above and beyond just the advantages of each specific modality. For example, it is known in the art that advantage is gained by combining SPECT and CT in a dual-modality system with each mode mounted on separate gantries with the patient supported and transported between them. Such a system allows for more accurate fusion of structural (e.g., anatomical) CT data and functional (e.g., perfusion and viability) SPECT data due to decreased patient movement.

Integrated multi-modality medical imaging systems also have recently been proposed, having one or more gamma cameras and a flat panel x-ray detector mounted on a common gantry to perform CT and SPECT studies. The gantry has a receiving aperture, a flat panel x-ray detector is mounted to rotate about the receiving aperture, and a gamma ray detector also is mounted to rotate about the receiving aperture. See, e.g., U.S. Pat. No. 7,075,087 to Wang et al., incorporated herein by reference in its entirety.

Additionally, it is known to combine a PET scanner with an X-ray CT scanner in order to provide anatomical images from the CT scanner that are accurately co-registered with the functional images from the PET scanner without the use of external markers or internal landmarks. See, e.g., U.S. Pat. No. 6,490,476 issued to Townsend et al., incorporated herein by reference in its entirety.

In computed tomography applications, two-dimensional (2D) projection images are acquired at multiple angular positions or views with respect to the patient orientation, and the 2D projection data thus acquired are then processed to generate a three-dimensional (3D) image volume from which various tomographic “slice” images can be reconstructed.

However, when motion of the patient occurs during the projection data acquisition procedure, its spatial orientation in the 3D volume changes, which causes its representation in the projection space to change relative to projection data acquired prior to the motion, thereby resulting in a positional error between different 2D projection views. Such positional errors propagate throughout the generation of the 3D image volume, and result in the appearance of motion artifacts in the reconstructed tomographic images obtained from the 3D image volume. Imaging procedures that require relatively long amounts of time for data acquisition, such as SPECT or dynamic PET, where data acquisitions often require from 20 to 30 minutes or more, are more susceptible to patient motion, as it becomes more and more difficult for a patient to continue to remain still as time goes by. In addition to body motion, artifacts may be caused by motion of a specific organ, such as diaphragmatic motion, “cardiac creep,” etc, which alter the spatial representation of the radionuclide distribution.

Numerous approaches have been proposed for correction of acquired projection data for motion-related inaccuracies. See, e.g., U.S. Pat. No. 6,473,636 to Wei et al., incorporated herein by reference. The vast majority of these approaches involve analysis solely of the functional projection images for motion detection, estimation and correction, without any consideration of the actual anatomical shape or position of the object under examination. See, e.g., U.S. Pat. No. 6,535,570 to Stergiopoulos et al., also incorporated herein by reference.

Despite the advances that have been made in imaging systems for acquisition of multi-modality imaging data, there remains a need for improvement in the accuracy of such data as presented to the clinician to improve the accuracy and efficiency of defect detection or assessment accuracy.

### SUMMARY OF THE INVENTION

An aspect of the present invention provides a method and system for detecting the presence of motion in functional medical imaging data by comparison with anatomical medical imaging data derived from reconstructed anatomical images. Detected motion in the functional data is then estimated and corrected.

An aspect of the present invention is based inter alia on the fact that the time duration required for anatomical image data acquisition, such as by CT, MRI or ultrasound apparatus, is much shorter than that required for functional NM data acquisition, which thereby substantially reduces the likelihood of any object motion during anatomical data acquisition significantly affecting the anatomical image volume, as compared with a functional image volume. For example, a cardiac image volume can be acquired on a multi-slice hybrid CT scanner in less than one minute, whereas acquisition of a NM image volume using the same hybrid scanner typically requires 20 to 30 minutes or more.

In accordance with an aspect of the invention, CT object templates are derived from reconstructed CT images. The CT object templates are assumed to be free of motion-related artifacts. NM functional projection images are compared with the CT object templates as a point of reference to detect, estimate and correct the NM projection data for artifacts caused by object motion, provided that the NM biomarker distribution has a known or identifiable relationship to the CT reference image.

### BRIEF DESCRIPTION OF THE DRAWINGS

FIG. 1 is a perspective view of a scanner for nuclear medical imaging of the type usable with the concepts of the present invention; and

FIG. 2 is a flow diagram illustrating the steps involved in correcting NM functional image data for motion-related artifacts in accordance with an embodiment of the invention.

### DETAILED DESCRIPTION OF THE EXEMPLARY EMBODIMENTS

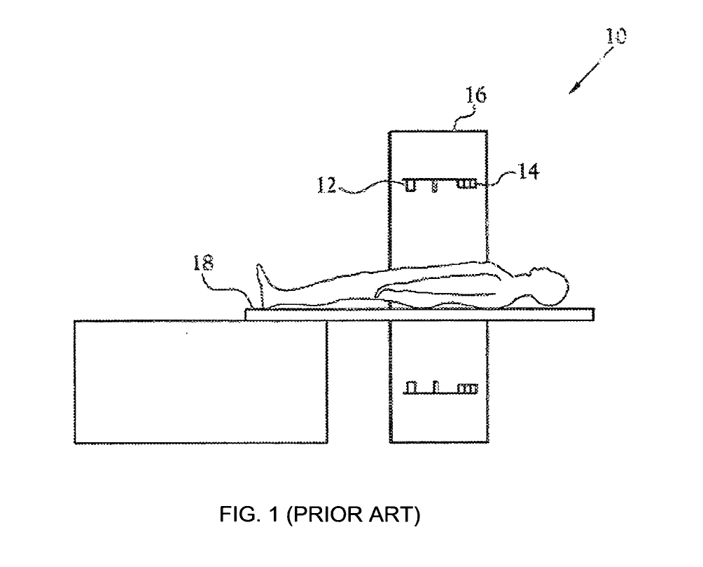

FIG. 1 shows one example of a multi-modality imaging system in the form of a hybrid or combination NM and X-Ray CT scanner apparatus 10 that allows registered CT and PET image data to be acquired sequentially in a single device, which is applicable to the methods of the present invention. Similar configurations could be used for other combinations of imaging modalities, such as SPECT/CT, SPECT/MR etc.

In the example of FIG. 1, the hybrid scanner 10 combines a Siemens Somatom spiral CT scanner 12 with a rotating PET scanner 14. The hybrid scanner 10 includes a PET scanner 14 and a CT scanner 12, both commercially-available, in a physically known relationship one with the other. Each of the X-ray CT scanner 12 and the PET scanner 14 are configured for use with a single patient bed 18 such that a patient may be placed on the bed 18 and moved into position for either or both of an X-ray CT scan and a PET scan. In a SPECT configuration, the scanners 14 would represent single photon emission detectors (in the example of FIG. 1, a dual-head SPECT detector would be represented; alternatively, a single detector head also could be used for SPECT data acquisition).

As shown, the hybrid scanner 10 has X-ray CT detectors 12 and NM (PET or SPECT) detectors 14 disposed within a single gantry 16, and wherein a patient bed 18 is movable therein to expose a selected region of the patent to either or both scans. Image data is collected by each modality and then stored in a data storage medium, such as a hard disk drive, for subsequent retrieval and processing.

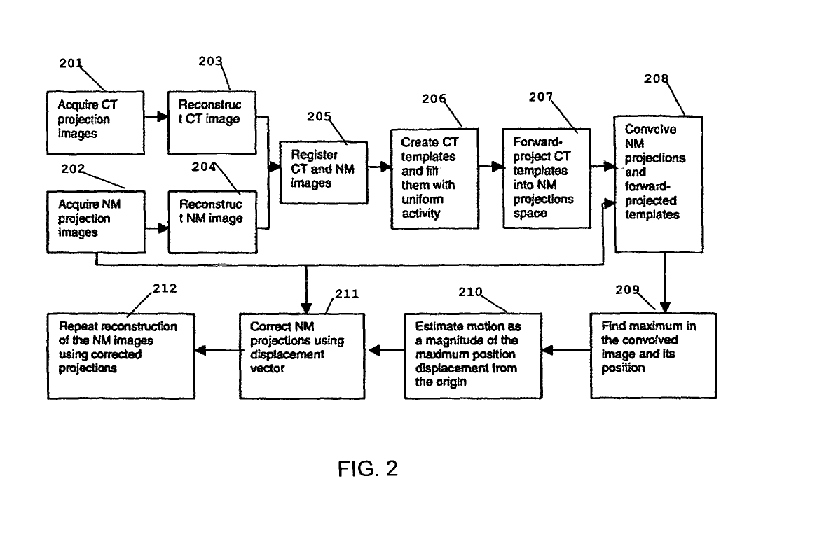

FIG. 2 shows an exemplary process according to an embodiment of the present invention. At step 201, CT projection data are acquired for an image volume including an object such as a patient's heart, and at step 202, NM (e.g., SPECT or PET) projection data are acquired for the same volume. At step 203, CT images are reconstructed for the CT image volume, providing for a number of various tomographic images or “slices” through different planes in the CT volume. At step 204, NM images are reconstructed for the NM image volume, providing for a number of various tomographic images or “slices” through different planes in the CT volume.

At step 205, the CT and NM image volumes are co-registered. Co-registration of multi-modality images is well known in the art; see, e.g. U.S. Published Patent Application No. 2006/0004274 A1 to Hawman, incorporated herein by reference; 2006/0004275 A1 to Vija et al., incorporated herein by reference; 2005/0094898 A1 to Xu et al., incorporated herein by reference. Accordingly, image co-registration will not be further described herein. However, it is noted that for hybrid scanners, the image co-registration step may be omitted where the coordinate space for both CT and NM modalities is the same. For example, for registration purposes the NM image volume may be considered a reference (i.e., unchanged) volume and the CT image volume may be considered an object (i.e., changed) volume, and vice versa.

At step 206, organ templates of the object of interest (e.g., the left ventricle (LV) of the heart) are derived from the reconstructed CT image data by generating a mask containing non-zero pixel values only for spatial coordinates corresponding to areas including the object, and zero pixel values everywhere else. The mask volume is then re-formatted into a volume having the same voxel (i.e., volume element) and matrix dimensions as the NM volume. The non-zero CT mask voxels are then assigned a predefined uniform value or number that is similar to the NM values for the object (e.g., in the case of cardiac imaging, the non-zero CT mask voxels each may be assigned the mean LV value of the corresponding NM image data).

At step 207, the re-formatted, uniform value CT mask templates are forward-projected from the CT object volume to a “reference” NM projection space. The reference NM projection space is based on the device model of the corresponding NM device, which includes the NM detector response model, patient-specific attenuation data, and scatter model. Additional parameters may be included in the model such that the reference projection space may also take into account other phenomena such as statistical or “Poisson” noise, and pharmacodynamic or pharmacokinetic properties of the particular radiopharmaceutical or biomarker used in the NM imaging application.

Next, at step 208, the forward-projected CT mask templates in the NM reference projection space are convolved with the original NM projections as acquired at step 202 to produce a convolution matrix for each projection. To avoid detection of false maximums, the convolution operation may be limited to a predetermined search area, such as a predefined area surrounding the object of interest. At step 209, the maximum value of the convolution matrix is determined, and its spatial location is identified in order to detect whether object motion has occurred. For instance, where the maximum value of the matrix is located at the origin (i.e., pixel (0,0)), no motion has occurred and the object positioning within the NM projection space is considered to be accurate. Where the location of the maximum value is at a pixel other than the origin (0,0), this indicates that object motion has occurred in the NM projection space, and processing advances to step 210.

At step 210, the displacement of the NM projection data caused by the detected motion is estimated. Motion estimation can be performed by a number of different methods generally known in the art, based on the interpolation of maximum position displacement from the origin of the convolution matrix, to obtain a displacement vector. See, e.g., U.S. Pat. No. 5,973,754 to Panis, U.S. Pat. No. 5,876,342 to Chen et al., U.S. Pat. No. 5,635,603 to Karmann, U.S. Pat. No. 4,924,310 to von Brandt, and U.S. Pat. No. 4,635,293 to Watanabe et al., all incorporated herein by reference. Accordingly, no further explanation of motion estimation is provided herein.

At step 211, the NM projection data are corrected for the effects of object motion by application of the displacement vector obtained in step 210. It is noted that a predefined threshold may be used for the displacement vector, such that corrections are performed only when the displacement vector exceeds such predefined threshold. Next, at step 212, the NM images are again reconstructed for the NM image volume using the motion-corrected and motion-free NM projection data obtained in step 211. The operation is repeated for each projection acquisition angle and/or temporal instance. Additionally, the entire operation of image data reconstruction, optional registration, template creation, forward projection, motion detection and estimation, and correction of projection data can be repeated iteratively until a minimum displacement vector magnitude (or other type of convergence criterion such as sinusoidal function conformance in sonogram space, maximized image content of the object of interest) or a combination of convergence criteria is obtained.

While embodiments of the invention have been described in detail above, the invention is not intended to be limited to the exemplary embodiments as described. It is evident that those skilled in the art may now make numerous uses and modifications of and departures from the exemplary embodiments described herein without departing from the inventive concepts. For example, in addition to correction of NM projection data for object motion within the projection space, the present invention also can be applied to NM partial volume and volume of distribution correction in a sonogram space, overlying visceral activity in cardiac PET and SPECT, and improvements in attenuation correction of NM studies.

What is claimed is:

1. A method for correcting nuclear medical image projection data of an object in a projection space for effects of object motion, comprising the steps of:
acquiring anatomical image projection data of said object in said projection space;
reconstructing said anatomical image projection data to obtain reconstructed anatomical image data;
creating an anatomical object template for said object from said reconstructed anatomical image data;
adjusting said template as necessary to make it compatible with said nuclear medical image projection data;
convolving said adjusted template with said nuclear medical image projection data to obtain a convolved image;
detecting motion of said object from said convolved image;
estimating the amount of motion of said object detected from said convolved image; and
correcting said nuclear medical image projection data using said estimated amount of motion to obtain motion-corrected projection data.

2. The method of claim 1, wherein said anatomical image projection data is obtained by using an anatomical imaging modality selected from the group consisting of CT, MRI and ultrasound.

3. The method of claim 1, further comprising the step of co-registering said reconstructed anatomical image data with reconstructed nuclear medical image data prior to creation of said template.

4. The method of claim 1, wherein said nuclear medical image projection data is PET data.

5. The method of claim 1, wherein said nuclear medical image projection data is SPECT data.

6. The method of claim 1, wherein the step of adjusting said template comprises the step of re-formatting said template into a volume having similar voxel and matrix dimensions as a volume of said nuclear medical image data.

7. The method of claim 6, further comprising the step of inserting uniform pixel values into said template at areas corresponding to said object.

8. The method of claim 1, wherein the step of convolving comprises the step of obtaining a convolution image matrix.

9. The method of claim 8, wherein the step of detecting motion comprises the step of identifying a maximum value in said convolution image matrix and determining the spatial location of said identified maximum value.

10. The method of claim 1, wherein the step of estimating motion comprises the step of obtaining a motion displacement vector.

11. The method of claim 10, wherein the step of correcting said nuclear medical image projection data comprises applying said motion displacement vector to said nuclear medical image projection data to obtain motion-corrected projection data.

12. The method of claim 1, further comprising the step of repeating said steps of convolving, detecting, estimating and correcting motion-corrected projection data until a predetermined convergence criterion is achieved.

13. A system for correcting nuclear medical image projection data of an object in a projection space for effects of object motion, comprising:
an anatomical imaging modality scanner that acquires anatomical image projection data of said object in said projection space;
a nuclear imaging modality scanner that acquires anatomical image projection data of said object in said projection space; and
a processor, which reconstructs said anatomical image projection data to obtain reconstructed anatomical image data; creates an anatomical object template for said object from said reconstructed anatomical image data; adjusts said template as necessary to make it compatible with said nuclear medical image projection data; convolves said adjusted template with said nuclear medical image projection data to obtain a convolved image; detects motion of said object from said convolved image; estimates the amount of motion of said object detected from said convolved image; and corrects said nuclear medical image projection data using said estimated amount of motion to obtain motion-corrected projection data.

14. The system according to claim 13, wherein said anatomical imaging modality scanner is selected from the group consisting of CT, MRI and ultrasound scanners

15. The system according to claim 13, wherein nuclear medical imaging modality scanner is selected from the group consisting of PET and SPECT scanners.
